(19) United States
(12) Patent Application Publication
(10) Pub. No.: US 2003/0191736 A1
(43) Pub. Date: Oct. 9, 2003

(54) System and method for managing access to information on a network

(75) Inventors: Robert Reid, Ottawa (CA); Donald Slaunwhite, Ottawa (CA); Richard Mutzke, Ottawa (CA)

Correspondence Address: Hayes, Soloway, 130 W. Cushing Street, Tucson, AZ, 85701, US

(73) Assignee: COREL CORPORATION

(21) Appl. No.: 10/118,190

(22) Filed: Apr. 8, 2002

(51) Int. Cl. G06F 7/00

(52) U.S. Cl. 707/1

(57) ABSTRACT

A connector unit connects information on a network with one or more software applications. The connector unit has a network access controller for providing information access functions for allowing users to access information on a network. It uses a configurable connector user interface for displaying, on an output device, information accessed through the network access controller and one or more user interface elements for controlling the information access functions of the network access controller. The settings of the connector user interface is configurable by the user.

This invention relates to a system and method for managing access to information, and more particularly, to a system and method for managing access to information on a network from applications.

### BACKGROUND OF THE INVENTION

There exist software applications that allow users to access the Internet from the applications. Some applications provide a button in their toolbar to launch a new instance of user's default web browser, such as Netscape Communicator (™ of Netscape Communications Corporation) or Internet Explorer (™ of Microsoft Corporation). These web browsers typically use up a large amount of real estate or size on the screen, and require user manipulation in order to have their size reduced. Also, this approach provides inconsistent results, depending on which browser(s) is installed, and which is set to be the default browser.

Some software applications include Internet connectivity built into them. When the Internet connectivity is called from the application, it opens a new window containing a web browser. The new window typically has a predetermined size and displayed at a predetermined location on the screen. The advantage of having a web browser in a predetermined window is that screen real estate is kept to a minimum or smaller compared to those launching a new instance of user's default web browser.

In these applications, typically the web browser is initially directed to a default web site that relates to the application. However, once the web browser is opened, the user has access to the entire Internet, simply by typing a different Internet “address” known as a Universal resource Locator (URL) in a control provided in the web browser window. This may cause concern for some businesses, which may have policies in place to limit Internet access. However, there is no mechanism to prevent the user from accessing the entire Internet, or no means to actively control the content of the web browser.

A module is available to incorporate Internet connectivity into an application. For example, U.S. Pat. No. 6,101,510 issued to Stone et al on Aug. 8, 2000 discloses a web browser control that incorporates web browsing functionality into an application. The application in turn incorporates the web browser controls into its own user interface. This web browser control allows easy incorporation of Internet connectivity, but still suffer the above described problems.

According to these approaches, the Internet connectivity is incorporated into each application individually. Thus, there exists the potential for user confusion, as each application provides its own format, in terms of placement and sizing of the web browser control, for viewing the Internet.

Furthermore, each application has its own browser window, independent of the other applications. This means that actions within one browser window in one application have no impact on the browser window in any other application. Thus, if the user wants to view the same information, the user needs to specify a URL in each browser window. The above approaches offer no simple means of managing the numerous instances of web browsers with which the user is presented.

It is therefore desirable to provide a mechanism that allows users to manage access to information on the Internet or other network from applications.

### SUMMARY OF THE INVENTION

It is an object of the invention to provide a novel system and method for managing access to information on a network from applications that obviates or mitigates at least one of the disadvantages of existing systems.

The present invention uses a single connector unit for managing information access from one or more applications. The connector unit has its own user interface that can be configured by users to allow central management.

In accordance with an aspect of the present invention, there is provided a connector unit for connecting information on a network with one or more software applications. The connector unit comprises a linking unit, a network access controller, a configurable connector user interface and a user interface manager. The linking unit links with one or more software applications. The linking unit allows the connector unit being launched from the applications. The network access controller provides information access functions for allowing users to access information on a network. The configurable connector user interface displays, on an output device, information accessed through the network access controller and one or more user interface elements for controlling the information access functions of the network access controller. The user interface manager is provided for configuring settings of the connector user interface.

In accordance with another aspect of the present invention, there is provided a method for managing access to information on a network from one or more software applications. The method comprises steps of receiving from an application a request for information on a network; reading settings of a connector user interface that provides a connector window to display the information, the settings of the connector user interface specifying one or more user interface elements to be displayed; and displaying the information and the user interface elements according to the settings of the connector user interface.

In accordance with another aspect of the present invention, there is provided a computer readable medium storing the instructions and/or statements for use in the execution in a computer of a method for managing access to information on a network from one or more software applications. The method comprises steps of receiving from an application a request for information on a network; reading settings of a connector user interface that provides a connector window to display the information, the settings of the connector user interface specifying one or more user interface elements to be displayed; and displaying the information and the user interface elements according to the settings of the connector user interface.

In accordance with another aspect of the present invention, there is provided electronic signals for use in the execution in a computer of a method for managing access to information on a network from one or more software applications. The method comprises steps of receiving from an application a request for information on a network; reading settings of a connector user interface that provides a connector window to display the information, the settings of the connector user interface specifying one or more user interface elements to be displayed; and displaying the information and the user interface elements according to the settings of the connector user interface.

In accordance with another aspect of the present invention, there is provided a computer program product for use in the execution in a computer of a method managing access to information on a network from one or more software applications. The computer program product comprises a module for receiving from an application a request for information on a network; a module for reading settings of a connector user interface that provides a connector window to display the information, the settings of the connector user interface specifying one or more user interface elements to be displayed; and a module for displaying the information and the user interface elements according to the settings of the connector user interface.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a block diagram showing a connector unit in accordance with an embodiment of the invention;

FIG. 2 is a block diagram showing an example of the connector unit;

FIG. 3 is a block diagram showing an example of a user interface manager 56 of the connector unit;

FIG. 4 is a screen shot showing an example of a connector window;

FIG. 5 is a screen shot showing another example of a connector window;

FIG. 6 is a flowchart showing the process of displaying a connector window;

FIG. 7 is a flowchart showing the process of enabling or disabling display of user interface elements;

FIG. 8 is a screen shot showing an example of an option dialog; and

FIG. 9 is a flowchart showing follow-me mode.

### DETAILED DESCRIPTION OF THE PREFERRED EMBODIMENTS

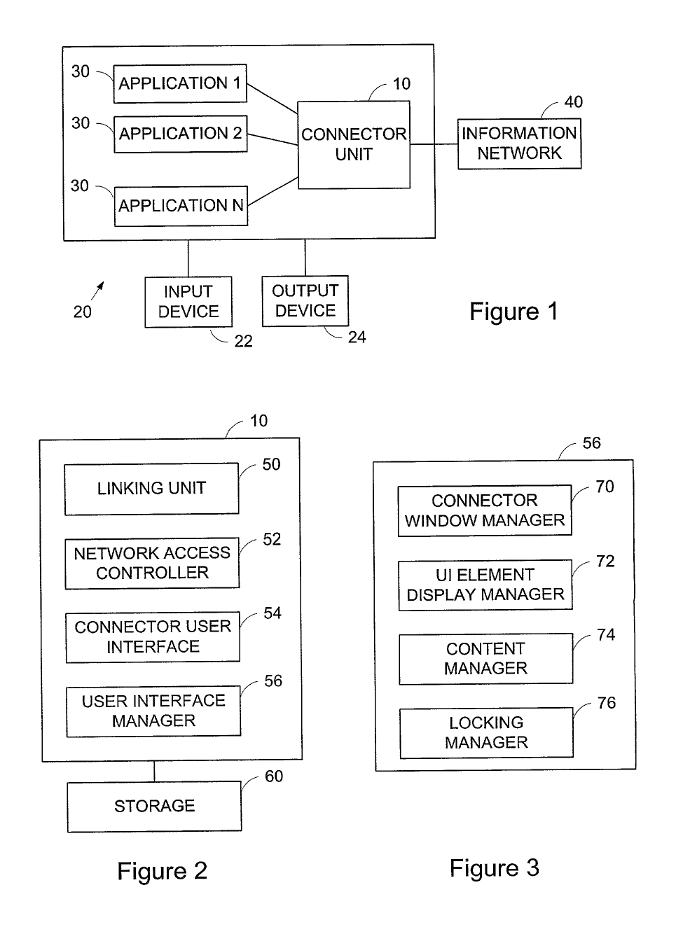

Referring to FIG. 1, a connector unit 10 in accordance with an embodiment of the present invention is described.

A connector unit 10 is installed in a computer system 20. The computer system 20 has one or more input devices 22 and one or more output devices 24. Input devices 22 may be a keyboard, pointing device, such as mouse or pen, and/or any other devices for inputting data by users. One of the output devices 24 is a display device for displaying output data on a screen. There may be other output devices, such as a printer, recording device and speaker.

In the computer system 20, there are also one or more software applications 30 installed. These applications 30 use the connector unit 10 to allow users to access information on a network 40 from the applications. The computer system 20 may have other applications (not shown) which do not use the connector unit 10. Hereinafter the term “application” is used to represent an application that is capable of using the connector unit 10, unless otherwise indicated.

The network 40 represents a user's local system, an internal network, local-area network (LANs) or external network, e.g., the Internet, or any combination thereof. The embodiment is further described mainly for accessing information on the Internet, however, the invention is not limited to the use for the Internet.

The connector unit 10 is a stand-alone application that can be used by one or more applications 30. The network information access functionality, e.g., web browser, is incorporated into the connector unit 10, rather than having each application incorporate it into its own user interface. Thus, network information accessing is centralised within a single application, which simplifies the users' access to the network 40.

The connector unit 10 has a programmatic interface that is configurable by users, as further described below. By providing the configurable user interface to the connector unit 10, it is also simple for users to manage the information access through the connector unit 10.

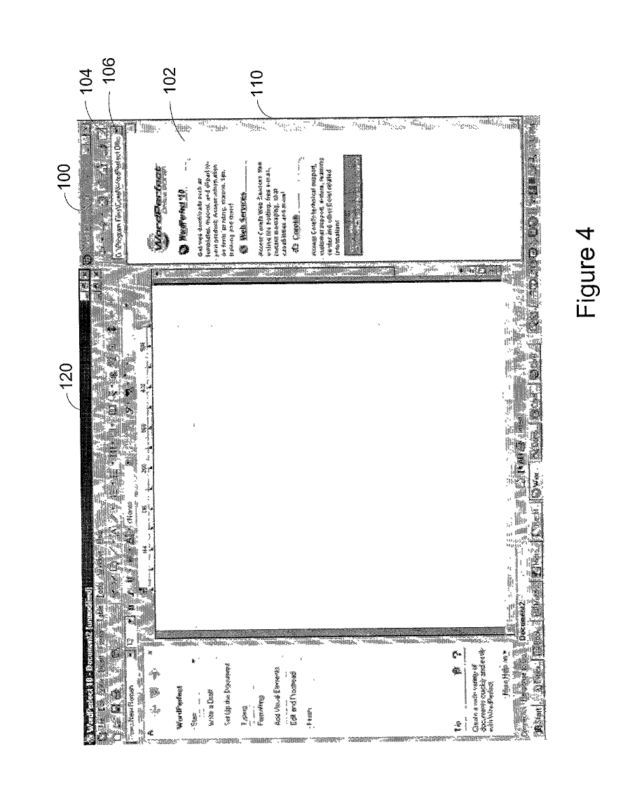

FIG. 2 shows an example of the connector unit 10. It includes a linking unit 50, network access controller 52, connector user interface 54 and user interface manager 56. The connector unit 10 is further described referring also to FIG. 4 which shows an example of a connector window 100.

The linking unit 50 links the connector unit 10 and each application 30 and allows communication between them. The linking unit 50 allows the connector unit 10 to be linked with multiple applications 30.

The linking unit 50 allows the connector unit 10 to be launched directly from the application 30. The application 30 may provide a user control in its interface, e.g., a button in a tool bar, to launch the connector unit 10. When the connector unit 10 is initially launched, it will open a new connector window 100 on the output device 24.

The network access controller 52 provides information access functions for allowing users to browse information on the network 40. The information access functions may include retrieving information specified by its address by a user, retrieving information of previous page or next page, searching information and/or other browsing functions.

The connector user interface 54 controls display in the connector window 100. It displays information accessed through the network access controller 52 in an information display section 102 of the connector window 100 as shown in FIG. 4. It also displays one or more user interface elements, such as tool bar 104, address bar 106 and/or other user controls, for allowing users to use the information access functions of the network access controller 52.

The information display section 102 may be created as a software module, so that other developers can incorporate the information display section 102 of the connector unit 10 into their applications. For example, it may be created as an ActiveX (™ of Microsoft Corporation) control based on Microsoft's Component Object Model (COM) architecture.

The user interface manager 56 manages configuration of the connector user interface 54. It allows users to specify what should be displayed in the connector window 100. It may allow various settings as further described below.

The configuration settings are preferably stored in a storage 60. When the connector unit 10 is shut down and relaunched, the entry in the storage 60 is read, and those settings are restored to the way they were prior to being shut down.

In an embodiment, the storage 60 may be dedicated to the connector unit 10. However, in a different embodiment, the storage 60 may be a part of a storage provided for saving various information to be used internally by the application and/or to be shared with other applications. As such a storage, a Microsoft database, Registry, may be suitably used.

As schematically shown in FIG. 3, the user interface manager 56 has connector window manager 70, user interface (UI) element display manager 72, information content manager 74 and locking manager 76. In this embodiment, the user interface manager 56 has all of these managers or functions, but in a different embodiment, a user interface manager 56 does not have to have all of these functions, and it may have one or more different functions.

The connector window manager 70 allows a user to set the initial size and location of the connector window 100 on the screen of the output device 24. For example, as shown in FIG. 4, the connector window 100 may be of a smaller size than the application window 120, and “attach” or dock itself to an edge 110 of the screen. By setting the window size and location in this way, the connector window 100 and the application window 120 may be viewed together. Docking the connector window 100 to an edge of the screen is advantageous as the connector window 100 always appears at the same location on the screen. Also, the connector window 100 remains docked for all applications 30. When the user switches the application to another, the connector window 100 remains the same location. Thus, users can easily locate the connector window 100 on the screen.

When the connector window 120 is opened, the size of the application window 120 may be automatically reduced so that both the connector window 100 and the application window 120 fit in the screen and share the entire display real estate.

The connector window manager 70 may also be used to set the connector window 100 to quickly and easily hide and reappear from the user's view. In this auto-hide mode, while the connector window 100 is displayed, when the user performs any predetermined action, e.g., bringing the mouse cursor on the application window 120, the connector window 100 disappears from the user's view. The connector unit 10 remains running without shutting down, and only hides its user interface from the user's view. Also, while the user is working in another application, the connector window 100 disappears until the user takes any predetermined action, e.g., bringing the mouse cursor over to the left or right edge of the display corresponding to where the connector window 100 was last displayed, at which time it will re-appear again.

The UI element display manager 72 allows the user to specify which UI elements are to be displayed in the connector window 100. By specifying which UI elements are to be displayed, the user can control which information access functions are available in the connector window 100.

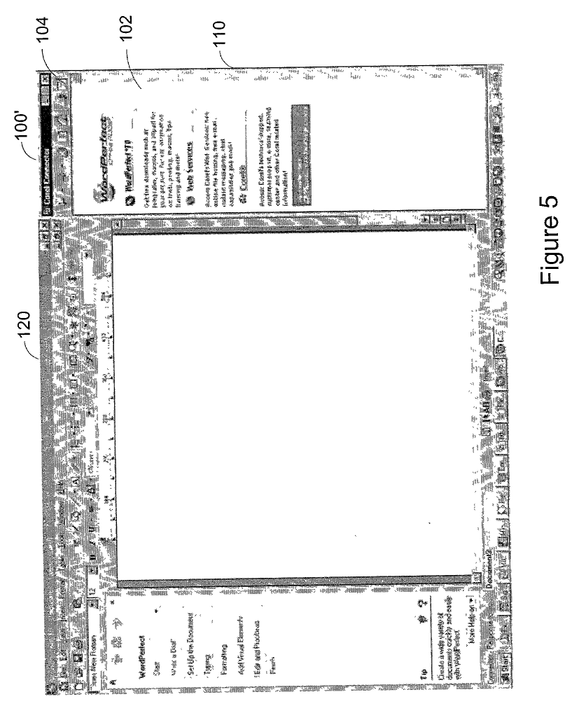

For example, in the connector window 100 shown in FIG. 4, address bar 106 is displayed. The user can type in a particular Universal Resource Locator (URL) in this address bar 106, which brings the user to that specified Internet location. Through this mechanism, the user can display any Web page that can be referenced via a URL. When it is preferable to restrict information that appears in the connector window 100, a user may set the UI element display manager 72 to disable the display of the address bar 106. In this case, as shown in FIG. 5, no address bar is displayed in the connector window 100′. If the user is connected to the Internet, the default home page is displayed in the information viewing area 102 of the connector window 100. The user may select hyperlinks from that home page to jump to other Internet locations. However, the user is limited to accessing Internet locations made available by the hyperlinks on those pages. The user is incapable of accessing any other web sites beyond those available from the default home page and its linked pages, since the address bar is hidden and there is no mechanism of manually entering a URL to access other Internet locations.

Similarly, a user may set to hide or display other user interface elements, such as a searching user control or the tool bar 104 containing one or more user controls.

The information content manager 74 allows users to specify the information content displayed in the connector window. It is typically set to display default information, or a default home page, that corresponds to the application from which the connector unit 10 was launched. For example, when the connector unit 10 is launched from WordPerfect (™ of Corel Corporation), the information related to WordPerfect is displayed. That is, if the user is connected to the Internet, the default home page for WordPerfect is displayed in the information viewing area in the connector window 100, as shown in FIG. 4.

The information content manager 74 may also allow users to set if the content of the window will follow switching of the applications, as further described below.

These settings may be stored in the storage 60 using one or more flags. The user sets up the storage 60 such that specific flags are set for configuring the connector unit 10. The connector unit 10 displays information and user interface elements according to the flags.

For example, if a user selects the option to disable the address bar 106, the connector unit 10 sets a flag in the storage 60 to store this information. It also disables the address bar according to the setting. When the user shuts down and restarts the connector unit 10, the connector unit 10 reads the address bar status from the storage 60 using the flag, and disables the address bar according to the address bar status. Thus, the address bar will still be disabled. The storage 60 may use various flags for other settings.

The locking manager 76 allows a user to lock one or more settings set through the managers 70-74. Typically, the locking manager 76 is used by authorized users, such as a system administrator. Locking of settings may be achieved by setting the relevant portion of the storage 60 to prevent users, other than the authorized users, from modifying that area of the storage 60. Thus, access to the information may be managed centrally by the system administrator.

For example, in a systems using the Registry and operating in a networked environment managed by a network administrator, those settings in the Registry can be locked down by the administrator by using Microsoft's Registry administration tool, regedt32.exe, such that a regular, non-administrative user cannot change those settings. Thus, if the address bar is set as disabled, the address bar cannot be re-enabled by a regular user.

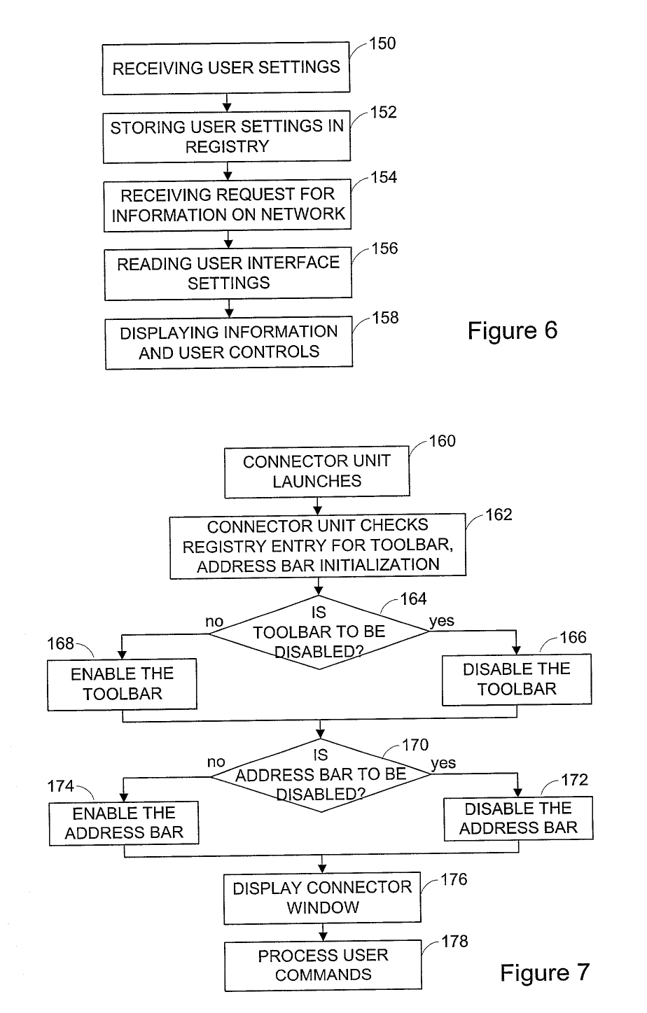

FIG. 6 shows general processing that the connector unit 10 follows when it starts up. The connector unit 10 receives settings specified by the user (150). If there is no setting specified by a user, it may use a default setting. The settings are stored in the storage 60 (152).

When an application 30 issues a request for information on network, the connector unit 10 receives the request (154) and launches itself. The connector unit 10 reads user interface settings from the storage 60 (156). The user interface settings specify information and one or more UI elements to be displayed. According to the settings, the connector unit 10 displays information and UI elements in a connector window on the output device (158).

FIG. 7 describes an example of the processing that the connector unit 10 follows when deciding which UI elements it needs to display while starting up. In this example, the connector unit 10 allows a user to enable or disable the toolbar 104 and address bar 106.

When the user selects a specific toolbar button in an application 30, the connector unit 10 launches (160). During initialization of the connector unit 10, prior to any aspect of the connector unit becoming visible to the user, the connector unit 10 checks the single entry in the storage 60 that defines various user interface settings for initialization of the toolbar and address bar (162). There are specific flags within the binary settings entry that are used to indicate whether the toolbar is to be disabled. If those flags are set (164), the connector unit 10 knows that it is to disable the display of the toolbar (166); otherwise, it enables the display of the toolbar (168). There are also specific flags within the binary setting that are used to indicate whether the address bar is to be disabled. If those flags are set (170), the connector unit 10 knows that it is to disable the display of the address bar (172); otherwise, it enables the display of the address bar (174). Once the connector unit 10 is ready to reveal a connector window after other initializations have been completed, it displays the connector window (176). The connector window includes those UI elements which are allowed to be revealed, and hides those UI elements that are to be hidden. These hidden UI elements cannot be made to be revealed by a non-administrator user. The connector unit 10 then processes further user commands (178).

In the above example, the flags are used to specify whether the toolbar and address bar are to be disabled. However, these flags may be used to specify that these bars are to be enabled or displayed. In that case, if those flags are set, the toolbar and address bar are displayed; otherwise, they are to remain hidden.

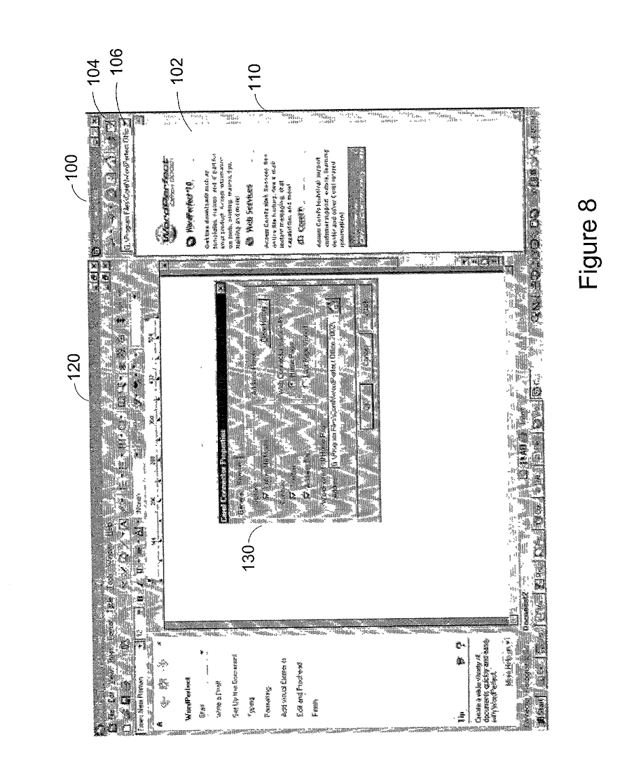

FIG. 8 shows an example of an options dialog 130 accessible from the connector unit 10. The user may use such option dialog 130, which provides check boxes to specify whether the toolbar and/or address bar will be displayed. Another options dialog may be provided for the user to specify how the window will behave, e.g., hide automatically or stay locked in size.

Since a single web browser in the connector window 100 is used by multiple applications 30, the contents of the connector window 100 may remain the same regardless which application 30 is currently active. This setting is convenient when the user wants to view the same information in the connector window 100 when applications 30 are switched. However, in different situations, the user may prefer information to remain relevant to the application 30 that is currently active. In order to provide this option, as indicated above, the information content manager 74 allows the user to select “follow-me” mode, i.e., to specify whether the contents in the connector window 100 are to “follow” the user's actions, depending on which application 30 is currently active. The option dialog 130 shown in FIG. 8 may also be used to enable or disable the “follow-me” mode.

In “follow-me” mode, when the user switches from one application to another, the connector unit 10 detects that it is losing focus on the original application, and then saves the web page or the location of the web page currently displayed in the connector window 100. When the user switches to or from another application, the connector unit 10 returns the user to the last-browsed web page corresponding to the newly activated application.

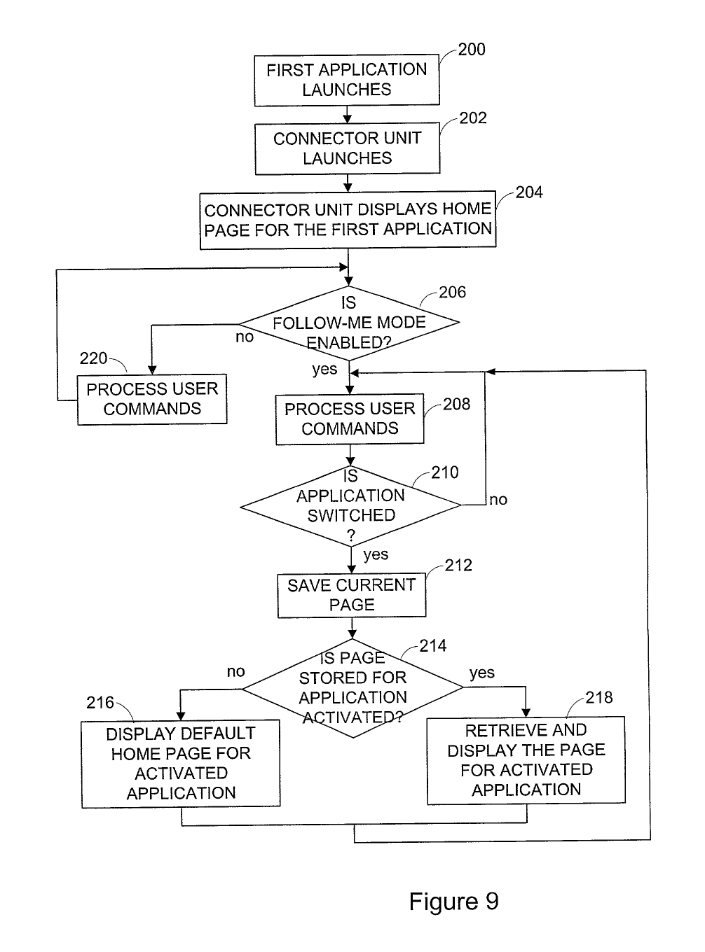

FIG. 9 shows an example of the processing that the connector unit 10 follows when the follow-me mode is selected.

The user launches a first application (200). When the user selects a toolbar button which launches the connector unit 10, the connector unit 10 is launched (202) and a connector window appears on the screen. If the user is connected to the Internet, the connector unit 10 displays the default home page for the first application in the main viewing area of the connector window (204). It may also display a toolbar and address bar, depending on the settings.

The user may enable or disable “follow-me” mode (206). The user may use an options button from a toolbar in the connector window to modify or verify the setting of the “follow-me” mode option.

When the follow-me mode is enabled (206), the connector unit 10 processes user commands (208) according to any other settings. When the user launches a second application (210) leaving the previous first application running, the connector unit 10 saves the current page for the first application (212). In this case, the home page of the first application is saved. If the auto-hide mode is enabled, the connector window disappears from the user's view. When the user selects a toolbar button which launches the connector unit 10 from the second application, the connector window reappears. The connector unit 10 checks if a page is stored for the newly activated second application (214). In this case, the second application was just launched and there is no page stored for it. Accordingly, if the user is connected to the Internet, the connector unit 10 displays the default home page for the second application in the main viewing area (216). Then it goes back to processing of the user commands (208).

If the user switches from the second application to the original first application (210), the connector unit 10 saves the current page appearing in the connector window for the second application (212). In this case, the home page of the second application is saved. The connector unit 10 then checks if there is any page stored for the first application (214). In this case, the home page of the first application is saved. Accordingly, the connector unit 10 retrieves this stored page and displays it automatically (218), without user intervention.

If the user selects a hyperlink from this home page of the first application, the connector unit 10 processes this selection (208) to bring the user to a first hyper linked page. If the user switches to the second application (210), the first hyper linked page that is currently displayed is saved for the first application (212). The connector unit 10 checks and finds the home page of the second application is saved, the current page appearing in the connector window is switched to the home page of the second application (218).

If the user selects a hyperlink from this home page of the second application, the connector unit 10 processes this selection (208) to bring the user to a second hyper linked page. If the user switches back to the first application (210), the second hyper linked page is saved for the second application (212). As the first hyper linked page is saved for the first application (214), the connector unit 10 retrieves it and the current page appearing in the connector window switches back to the first hyper linked page selected from the home page of the first application (218).

If the user launches a third application (210) leaving the previous two applications running, the connector unit saves the current page, the first hyper linked page, for the first application (212). As no page is saved for this newly launched third application (214), the connector unit 10 displays the default home page of the third application in the main viewing area (216).

If the user switches back to the first application (210), the connector unit 10 saves the currently displayed home page of the third application for the third application (212). As the first hyper linked page is saved for the first application (214), the connector unit 10 retrieves it and displays it back (218).

Similarly, if the user switches to the second application (210), the connector unit 10 switches back to the second hyper linked page saved for the second application (218).

If the user switches to the third application (210), the connector unit 10 switches back to the home page of the third application that is saved for the third application (218).

The connector unit of the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

Since the connector unit may be implemented as a stand-alone application, it can be shipped, downloaded, and/or sold separately. Though it cannot be programmatically controlled by existing applications already installed on the user's system, it integrates seamlessly with those applications.

While particular embodiments of the present invention have been shown and described, changes and modifications may be made to such embodiments without departing from the true scope of the invention. For example, the elements of the connector unit are described separatory, however, two or more elements may be provided as a single element, or one or more elements may be shared with other component in the computer systems.

What is claimed is:

1. A connector unit for connecting information on a network with one or more software applications, the connector unit comprising:
a linking unit for linking with one or more software applications, the linking unit allowing the connector unit being launched from the applications;
a network access controller for providing information access functions for allowing users to access information on a network;
a configurable connector user interface for displaying, on an output device, information accessed through the network access controller and one or more user interface elements for controlling the information access functions of the network access controller; and
a user interface manager for configuring settings of the connector user interface.

2. The connector unit as claimed in claim 1 wherein the user interface manager include a user interface element display manager for setting display of one or more user interface elements.

3. The connector unit as claimed in claim 2 wherein the user interface element display manager enables or disables display of an address control that allows a user to specify an address of information to be retrieved.

4. The connector unit as claimed in claim 2 wherein the user interface element display manager enables or disables display of a tool that allows a user to browse on the network.

5. The connector unit as claimed in claim 1 wherein the user interface manager include a content manager for managing content of the information to be displayed.

6. The connector unit as claimed in claim 5 wherein the content manager allows a user to set a default information depending on an application from which the connector unit is used.

7. The connector unit as claimed in claim 5 wherein the content manager allows a user to set the content displayed to follow switching of applications from which the connector unit is used.

8. The connector unit as claimed in claim 1 wherein the user interface manager include a connector window manager for managing appearance of a connector window in which the information and user interface elements are displayed.

9. The connector unit as claimed in claim 8 wherein the connector window manager allows a user to set the connector window to automatically hide and reappear depending on user actions.

10. The connector unit as claimed in claim 8 wherein the connector window manager allows a user to set the location of the connector window on a screen of the output device.

11. The connector unit as claimed in claim 8 wherein the connector window manager allows a user to set the size of the connector window on a screen of the output device.

12. The connector unit as claimed in claim 11 wherein the size setter causes resizing of an application window in which the application is displayed so that the application window and the connector window fit in the screen.

13. The connector unit as claimed in claim 1 wherein the user interface manager includes a locking manager for locking one or more settings of the connector user interface.

14. The connector unit as claimed in claim 13 wherein the locking manager permits one or more authorized users to alter settings of the connector user interface.

15. The connector unit as claimed in claim 1 wherein the connector unit includes a storage for storing settings of the connector user interface.

16. A method for managing access to information on a network from one or more software applications, the method comprising steps of:
receiving from an application a request for information on a network;
reading settings of a connector user interface that provides a connector window to display the information, the settings of the connector user interface specifying one or more user interface elements to be displayed; and
displaying the information and the user interface elements according to the settings of the connector user interface.

17. The method as claimed in claim 16 further comprising steps of:
receiving settings of the connector user interface entered by a user; and
storing the settings in a storage, and
wherein the reading step reads the settings from the storage.

18. The method as claimed in claim 17 wherein the settings receiving step includes a step of receiving settings of display of one or more user interface elements.

19. The method as claimed in claim 18 wherein the step of receiving setting of display receives an indication of enabling or disabling display of an address control that allows a user to specify an address of information to be retrieved.

20. The method as claimed in claim 18 wherein the step of receiving setting of display receives an indication of enabling or disabling display of a tool that allows a user to browse on the network.

21. The method as claimed in claim 17 wherein the settings receiving step receives settings of content of the information to be displayed.

22. The method as claimed in claim 21 wherein the settings receiving step receives an indication of a default information to be displayed depending on an application from which the connector unit is used.

23. The method as claimed in claim 21 wherein the settings receiving step receives an indication if the content displayed is to follow switching of applications from which the connector unit is used.

24. The method as claimed in claim 17 wherein the settings receiving step receives settings of a connector window in which the information and user interface elements are displayed.

25. The method as claimed in claim 24 wherein the settings receiving step receives an indication if the connector window is to be automatically hide or reappear depending on user actions.

26. The method as claimed in claim 24 wherein the settings receiving step receives an indication of the location of the connector window on a screen of the output device.

27. The method as claimed in claim 24 wherein the settings receiving step receives an indication of the size of the connector window on a screen of the output device.

28. The method as claimed in claim 27 further comprising a step of resizing an application window in which the application is displayed so that the application window and the connector window fit in the screen.

29. The method as claimed in claim 17 wherein the settings receiving step includes a step of locking one or more settings of the connector user interface.

30. The method as claimed in claim 29 further comprising a step of checking if a user is authorized to alter the settings.

31. A computer readable medium storing the instructions and/or statements for use in the execution in a computer of a method for managing access to information on a network from one or more software applications, the method comprising steps of:
receiving from an application a request for information on a network;
reading settings of a connector user interface that provides a connector window to display the information, the settings of the connector user interface specifying one or more user interface elements to be displayed; and
displaying the information and the user interface elements according to the settings of the connector user interface.

32. Electronic signals for use in the execution in a computer of a method for managing access to information on a network from one or more software applications, the method comprising steps of:
receiving from an application a request for information on a network;
reading settings of a connector user interface that provides a connector window to display the information, the settings of the connector user interface specifying one or more user interface elements to be displayed; and
displaying the information and the user interface elements according to the settings of the connector user interface.

33. A computer program product for use in the execution in a computer of a method managing access to information on a network from one or more software applications, the computer program product comprising:
a module for receiving from an application a request for information on a network;
a module for reading settings of a connector user interface that provides a connector window to display the information, the settings of the connector user interface specifying one or more user interface elements to be displayed; and
a module for displaying the information and the user interface elements according to the settings of the connector user interface.
